(19) United States
(12) Patent Application Publication
(10) Pub. No.: US 2006/0277009 A1
(43) Pub. Date: Dec. 7, 2006

(54) Simulation and modeling of rock removal control over localized zones for rock bit

(75) Inventors: Carlos Torres, Houston, TX (US); Zhou Yong, Spring, TX (US); Sujian Huang, Beijing (CN)

Correspondence Address: OSHA LIANG L.L.P., 1221 MCKINNEY STREET, SUITE 2800, HOUSTON, TX, 77010, US

(73) Assignee: Smith International, Inc., Houston, TX (US)

(21) Appl. No.: 11/143,871

(22) Filed: Jun. 2, 2005

(51) Int. Cl. G06G 7/48

(52) U.S. Cl. 703/6

(57) ABSTRACT

A method for designing a rock bit, involving dividing a bottomhole into a plurality of zones, simulating cutting of a rock formation by the rock bit in each of the plurality of zones, outputting results of the simulation, and analyzing the results of said simulation.

### BACKGROUND OF INVENTION

1. Field of the Invention

The invention relates generally to simulating and modeling the penetration control of a rock bit on the bottom of hole for improvement of bit performance.

2. Background Art

Roller cone rock bits and fixed cutter bits are commonly used in the oil and gas industry for drilling wells. FIG. 1 shows one example of a conventional drilling system drilling an earth formation. The drilling system includes a drilling rig 10 used to turn a drill string 12 which extends downward into a well bore 14. Connected to the end of the drill string 12 is roller cone-type drill bit 20, shown in further detail in FIG. 2. Roller cone bits 20 typically comprise a bit body 22 having an externally threaded connection at one end 24, and a plurality of roller cones 26 (usually three as shown) attached to the other end of the bit and able to rotate with respect to the bit body 22. Attached to the cones 26 of the bit 20 are a plurality of cutting elements 28 typically arranged in rows about the surface of the cones 26. The cutting elements 28 can be tungsten carbide inserts, polycrystalline diamond compacts, or milled steel teeth.

Significant expense is involved in the design and manufacture of drill bits. Therefore, having accurate models for simulating and analyzing the drilling characteristics of bits can greatly reduce the cost associated with manufacturing drill bits for testing and analysis purposes. The common practice, for the design of drill bits and drilling systems used to drill holes in subterranean formations, is to study motion and dynamics of a bit and its interaction with the surface of the rock formation on the bottom of the hole (i.e., how the cutters of the bit interact with the surface of the rock formation). It has been observed by the applicants that central to the activity of forming a hole in a subterranean formation is the removal of rock formation, whether in petroleum industries or in mining industries. The magnitude of stress, the magnitude of strain energy, the distribution of stresses, the distribution of strain energies, and other physical parameters underneath the bottom of a hole determine the penetration rate of a drilling system.

Typically, input energy by rotation and weight on a bit is unevenly distributed over the bottom of a hole. As a result, capacity of removing rock formation for an insert or row of the cutters on a bit varies on the surface bottom of the hole. Conventionally, when examining the removal of rock formation, the volume of rock removed is treated as one primary system. From the observation of the volume of rock removed, the focus has always been on the statistical analysis of the global summary of rock removal.

A bit can be designed so that the bits cuts rock formation with undesired differences of removal rates over different zones of the hole. This phenomenon may lead to some inserts on the cutters of a bit may be worn/broken faster than others, causing the global cutting rate to slow down. Further, differences of removal rates over different zones of the hole may cause inefficient usage of input energy by the bit. What is needed is a method for detailed evaluation of the contributions of individual rows and inserts of the cutters of a bit to local rock removal.

### SUMMARY OF INVENTION

In general, in one aspect, the invention relates to a method for designing a rock bit, comprising dividing the bottomhole into a plurality of zones, simulating cutting of a rock formation by the rock bit in each of the plurality of zones, outputting results of said simulation, and analyzing the results of said simulation.

In general, in one aspect, the invention relates to a system for designing a rock bit, comprising a bottomhole divided into a plurality of zones, and a simulation tool configured to simulate the cutting of a rock formation by the rock bit in each of the plurality of zones and configured to output results of the simulation, wherein the simulation tool is used to obtain an optimized cutting structure associated with the rock bit.

In general, in one aspect, the invention relates to a method for analyzing a bit design, comprising calculating an amount of rock removed in a first zone, calculating an amount of rock removed in a second zone, and analyzing the calculated amount of rock removed in the first zone and the second zone.

Other aspects and advantages of the invention will be apparent from the following description and the appended claims.

### BRIEF DESCRIPTION OF DRAWINGS

FIG. 1 shows a schematic diagram of a drilling system for drilling earth formations having a drill string attached at one end to a roller cone drill bit.

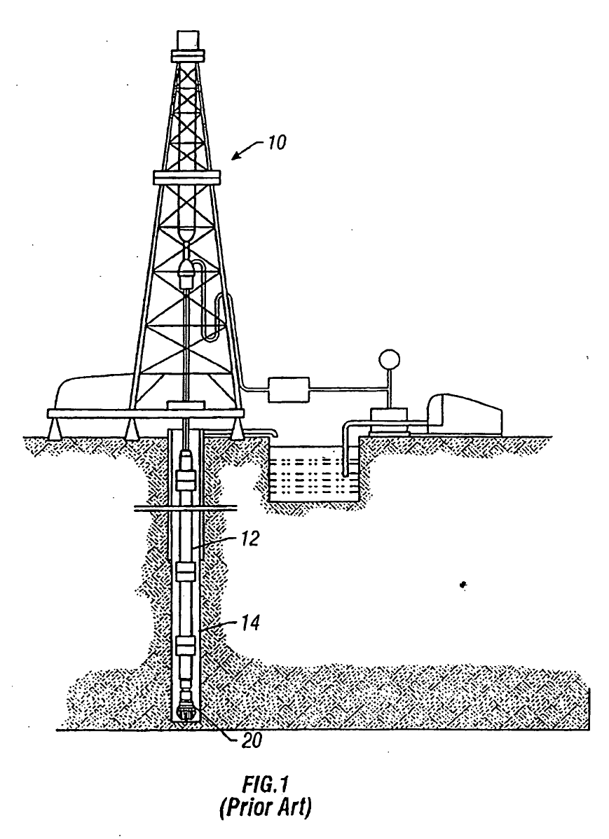

FIG. 2 shows a perspective view of a roller cone drill bit.

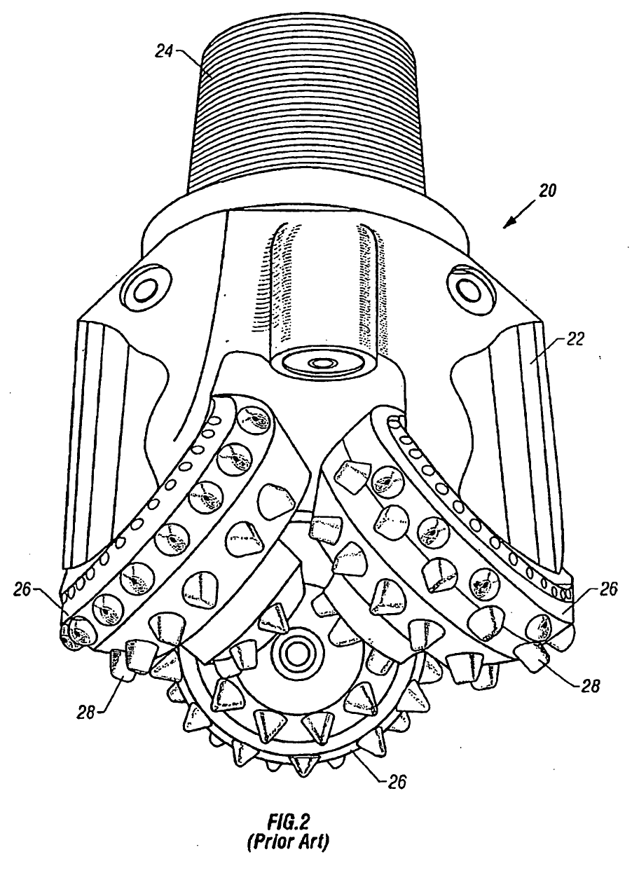

FIG. 3 shows a flow chart for designing a rock bit in accordance with one embodiment of the invention.

FIGS. 4a-4b show the bottom of a drill hole subdivided into concentric annual zones;

FIGS. 5a-5c show the bottom of a drill hole subdivided into fan-shaped zones;

FIGS. 6a-6c show the bottom of a drill hole subdivided into a combination of concentric annual zones and fan-shaped zones;

FIGS. 7a-7c show the bottom of a drill hole subdivided into less-limited zones.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of embodiments of the invention, numerous specific details are set forth in order to provide a more thorough understanding of the invention. In other instances, well-known features have not been described in detail to avoid obscuring the invention.

In general, embodiments of the invention relate to the simulation and modeling of rock removal rates in different defined zones of the surface bottom of a drill hole. Specifically, embodiments of the invention relate to finding an optimized cutting structure corresponding to different designs on cutting structures of bits that generates desired rock removal rates on defined local zones using simulation and modeling tools, resulting in the improved penetration rate and durability of the cutters on the bit, when compared to a prior art bit.

Embodiments of the invention relate to simulating and analyzing the rock removal rate of a rock bit. Specifically, the rock removal rate is the rate at which a cutting structure of a rock bit removes rock formation from the surface of the bottomhole as the rock bit is drilling in the bottomhole. Further, as a rock bit is removing rock formation, the rock bit may be damaged by, for example, wear, and its cutting profile can change. One notable effect of the change in cutting profile is that the bit drills a smaller diameter hole than when new. Changes in the cutting profile and in gage diameter act to reduce the effectiveness and useful life of the bit. Other wear-related effects that are less visible also have a dramatic impact on drill bit performance. For example, as individual cutting elements experience different types of abrasive wear, they may wear at different rates. As a result, a load distribution between roller cones and between cutting elements may change over the life of the bit. These changes may be undesirable if, for example, a specific roller cone or specific rows of cutting elements are exposed to a majority of axial loading. This may cause further uneven wear and may perpetuate a cycle of uneven wear and premature bit failure.

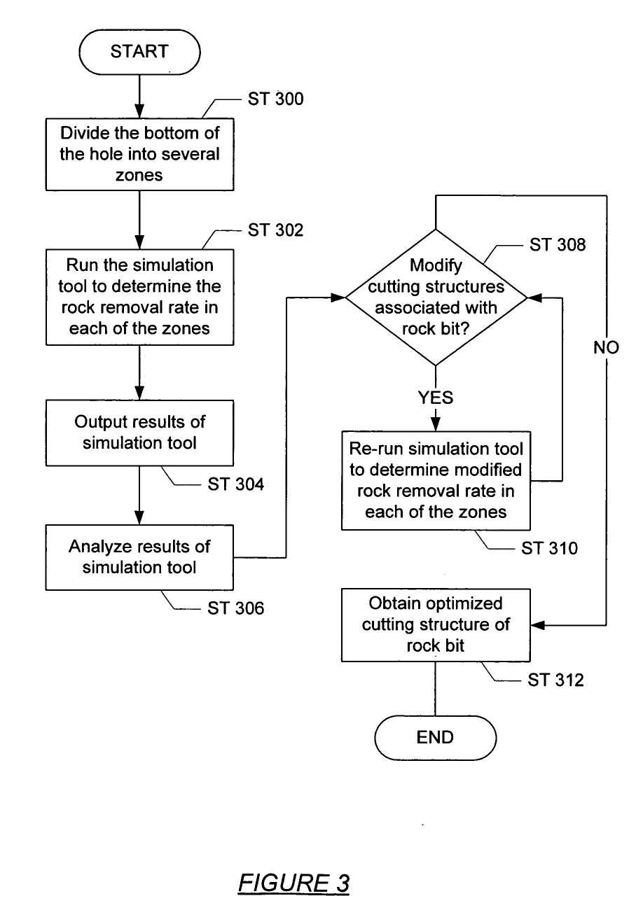

FIG. 3 shows a flow chart for designing a rock bit in accordance with one embodiment of the invention. Although not shown in FIG. 3, simulating the rock removal rate of a rock bit initially involves selecting rock formation parameters and cutting structure design parameters. Such parameters include, but are not limited to, cutting element geometry, radial placement of the cutting element on the blade or bit, back rake angle, cutting element spacing, material properties, and bevel size, the hardness of rock formation encountered by the rock bit, etc. Selecting the aforementioned parameters allows the simulation tool to simulate both the rock formation to be removed and the type of cutting structures that contact the rock formation to be removed.

Beginning with FIG. 3, initially, the bottom of the drill hole (i.e., bottom hole) is divided into several zones (Step 300). In one embodiment of the invention, zones may be concentric annual zones with a circle in the center, fan-shaped zones, a combination of fan-shaped and concentric annual zones, or less-limited zones. Depending on the type of formation to be drilled, a design may select one or more of the zones when running a simulation. In one embodiment of the invention, a rock sample from a formation of interest may be taken, in order to serve as the basis for determining the zones. This may be particularly advantageous when modeling an inhomogeneous formation.

Further, in one embodiment of the invention, the bottom of the drill hole may be divided into zones based on particular criteria. For example, the bottom of the drill hole may be divided into several zones based on surface area. More specifically, surface area of a zone may be planar or curved. Specifically, several zones may be formed by examining the surface area of the bottom of the drill hole. In one embodiment of the invention, zones may be divided such that the surface area of each zone is equal to at least one other zone. Alternatively, the difference in the surface area between zones may be less than forty percent. Another criteria that may be used to divide the bottom of the drill hole into several zones is energy distribution. Energy distribution may include, but is not limited to, kinetic energy, work by weight on a bit, and energy calculated by stresses, deformation, or fragmentation within the rock of the drill hole. In one embodiment of the invention, zones may be formed such that the energy distribution of each zone is equal to at least one other zone. Alternatively, the difference in the energy distribution between zones may be less than forty percent. Further, zones may be divided based on a combination of both the surface area and the energy distribution of the bottom of the drill hole.

Those skilled in the art will appreciate that if the bottom of the drill hole is divided based on one or more of the aforementioned criteria, the rock removal rate in a particular zone may be equal to the rock removal rate in another zone. Alternatively, the difference between the rock removal rates in two zones may proportionally correspond to the difference in the surface area/energy distribution of the two zones, or the rock removal rate for each zone may an optimized ratio between zones. In one embodiment of the invention, when the bottom of the drill hole is divided into several zones with significantly different surface areas/energy distributions, criteria may be adapted to fit the deviation in the zones.

Returning to FIG. 3, subsequently, a simulation/modeling tool is run (Step 302), which simulates a rock bit cutting the rock formation of the drill hole using the cutting structures associated with the rock bit. In one embodiment of the invention, the rock volume removed includes plastic and brittle rock removed. In one embodiment of the invention, a simulation tool as described in U.S. Pat. No. 6,516,293 may be used. This patent is incorporated by reference in its entirety. With respect to wear, it may be modeled using the techniques described in U.S. Pat. No. 6,619,411. This patent is incorporated by reference in its entirety. In addition to the simulation techniques set forth in these patents, mathematical techniques for modeling such a system may be used (i.e., finite element analysis, etc.). Those skilled in the art will appreciate that the term simulation or simulation tool is intended to cover both dynamic and static processes. Moreover, the term simulation, as used herein, is meant to include all techniques for predicting performance, whether theoretical or experimental in nature.

For example, cutting structures may include rows and inserts on the rock bit. In one embodiment of the invention, the simulation tool is used to determine the rock removal rate (i.e., the rate at which rock formation is removed by the rock bit when drilling the hole) in each of the zones of the bottomhole. In another embodiment of the invention, results produced by the simulation tool may be displayed (either graphically or numerically) on a cutting element, row, and/or cone basis. The results may be displayed in the form of tables, charts, 3-D displays, “real-time” graphics, and/or any other form that may be useful to a designer. The type of display is not intended to be limitation on the scope of the present invention. Further, while parts of the description focus on roller cone bits, it is expressly within the scope of the present invention that fixed cutter bits (or any other type of rock bit) may be modeled. In this case of fixed cutting bits, techniques, such as those disclosed in U.S. patent application Ser. No. 10/888,523 may be used. This application is incorporated by reference in its entirety.

Upon completion of the simulation, the results of the simulation are outputted (Step 304). In one embodiment of the invention, the simulation tool may have a selection panel (i.e., a user interface) from which a button labeled “Zoned Rock Removal” can be selected by a user to generate the output of the simulation results. The results of the simulation may be outputted to a designer or developer of the rock bit. Specifically, in selected embodiments of the invention, output results of the simulation include several curves that represent the cumulative rock volume removed in each zone, the incremental rock volume removed in each zone, the average depth drilled in each zone, the cumulative rate of penetration for each zone, the incremental rate of penetration for each zone, and the cumulative rate of penetration for several zones (including particular shaped zones, surface area zones, and energy distribution zones). The cumulative rock volume removed is the total rock formation removed in each zone, while the incremental rock volume removed represents the amount of rock removed in each step of the simulation. In one embodiment of the invention, average depth drilled in each zone is defined as the cumulative volume of the hole in the zone for which the average depth is being computed divided by the area of zone for which average depth in being computed. That is, Zₐᵥₑᵣ=(Cumulative Volume for Zone/Area of the Zone). Further, in one embodiment of the invention, results of the simulation may be output using a visual presentation, such as 2D graphs, 3D graphs, charts, etc.

Continuing with FIG. 3, upon gathering and outputting each of the aforementioned curves for each zone of the bottomhole, the results are analyzed by a designer or user of the simulation tool (Step 306). Specifically, the rock removal rate for each zone of the bottomhole is analyzed to determine whether the rock bit is cutting the rock formation at an optimized rate. In order to analyze the rock removal rate for each zone of the bottomhole, the stress imposed on each cutting structure of the rock bit is analyzed. The stress seen by each individual cutting structure differs from the stress seen by the other cutting structures based on various cutting structure design parameters. Cutting element design parameters may include, but are not limited to, cutting element geometry, radial placement of the cutting element on the blade or bit, back rake angle, cutting element spacing, material properties, and bevel size.

Further, the stress experienced by each cutting structure may be determined by finite element analysis (FEA), finite differences analysis (FDA), simulating the cutting elements contacting a formation, stress equations, work rate equations, or other comparable analysis techniques. For example, the contributions of individual rows and inserts of the cutting structures associated with the rock bit may be analyzed for each zone. Because input energy by rotation and weight on the rock bit is typically unevenly distributed over the bottomhole, capacity of removing rock formation for an insert or row varies on the surface of the bottomhole. Thus, analyzing the contribution of each row/insert of a cutting structure provides the designer/user with an overall picture of the rock removal rate.

Those skilled in the art will appreciate that many different parameters may be analyzed to determine the rock removal rate for each zone of the bottomhole, such as comparing the average depth drilled in each zone by each cutting structure of the rock bit, etc. Further, those skilled in the art will appreciate that cutting structures of the rock bit that are simulated and analyzed may include different designs, such as insert shapes, sizes, and distributions on a cone, cone profiles, journal angles and offsets, etc.

In analyzing the results, a determination is made whether the cutting structures parameters selected for the simulation need to be modified to obtain an improved rock removal rate for the rock bit (Step 308). If the cutting structures are to be modified to improve the penetration rate and durability of the rock bit, then the simulation tool is used to modify the cutting structures and the simulation tool is re-run to determine a modified rock removal rate in each zone based on the modified cutting structures (Step 310). Alternatively, if the cutting structures of the rock bit are not modified, then this implies that the simulation results produce an optimized cutting structure (Step 312) and the process ends.

Those skilled in the art will appreciate that the process shown in FIG. 3 may be repeated several times until a design has a desired performance characteristic or a combination of desired performance characteristics. Specifically, the process of FIG. 3 may be repeated until an optimized cutting structure is determined, which provides a desired rock removal rate. Further, the process of FIG. 3 allows an optimized layout for cutting structures associated with a rock bit to be selected to meet the design requirements for the best penetration rate of the rock formation being drilled. Finding an optimized layout for the cutting structures results in the best durability of the rock bit because the stress and pressure on each cutting structure is evenly distributed, resulting in less worn and broken cutting structures.

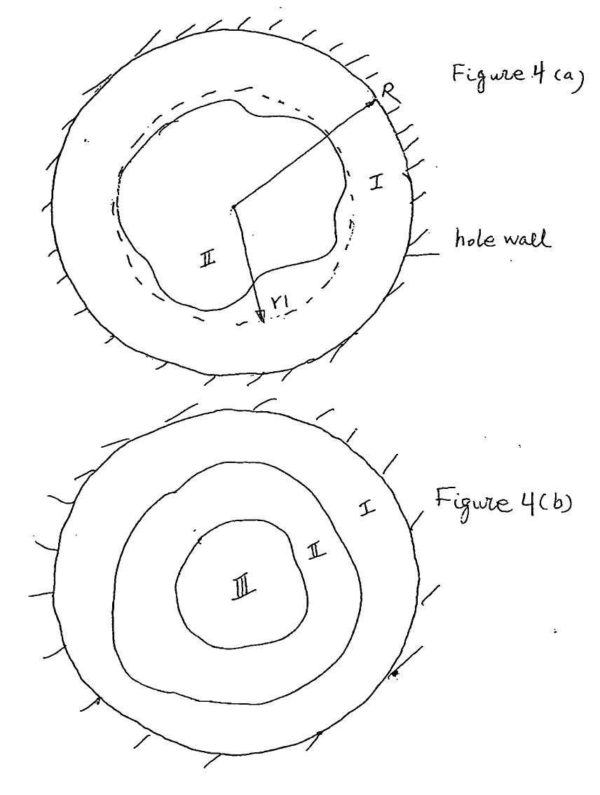

FIGS. 4a-4b show a bottomhole divided into concentric annual zones in accordance with one embodiment of the invention. In FIG. 4a, two zones are shown (i.e., Zone I, Zone II) with a circle at the center of the bottomhole. Further, the radius R represents the radius of the bottomhole, measured from the center of the circle shown with a dotted line to the edge of the hole wall. The radius r1 represents the radius from the center of the center circle to the edge of the center circle. In one embodiment of the invention, the bottomhole area may be separate into two zones, as shown in FIG. 4a. In this embodiment, the zones are shown as concentric circles. FIG. 4b is similar, but shows a plurality of zones. While reference has been made to roller cone bits, it is expressly within the scope of the present invention that fixed cutter bits may also be used.

Returning to FIG. 4a, Zone II is defined as a circular area where:
r₁<a×R (Eq. 1),
wherein R is the radius of the bottomhole/bit, and a is a variable constant, selected by the designer. Based on experience and modeling, the present inventors have discovered that an advantageous bit structure results when the cutting structure is arranged such that the rock removal rates in Zone I and Zone II are substantially equal when r₁=0.707R. This structure has been determined to use input energy more efficiently that prior art structures. Techniques for achieving such a result include changing the number of cutting elements, changing location of elements, and/or changing the number and location of rows of cutting elements.

Now, returning again to FIG. 4a, Zone I may be defined as:
a×R<r₁<R (Eq. 2).
Those having ordinary skill in the art will appreciate that the simulation may include both brittle and plastic rock removal. Again, the volume removed b a selected cutting element may be calculated (using, for example, FEA) or may be experimentally determined (e.g., by contacting a cutting element with a rock sample and measuring the crater formed.

Those skilled in the art will appreciate that the parameter a may be changed based on the type of rock bit, the type of rock formation, etc. Further, the parameter a may be changed based on experimental or theoretical results of the simulation of the rock removal rate in each zone. FIG. 4b shows that the bottomhole may be divided into three zones, where the above equation may be applied to each zone. Those skilled in the art will appreciate that a bottomhole may be dived into several zones, depending on the different types of rock formation that exist in the bottomhole, the type of rock bit or the cutting structures associated with the rock bit, etc.

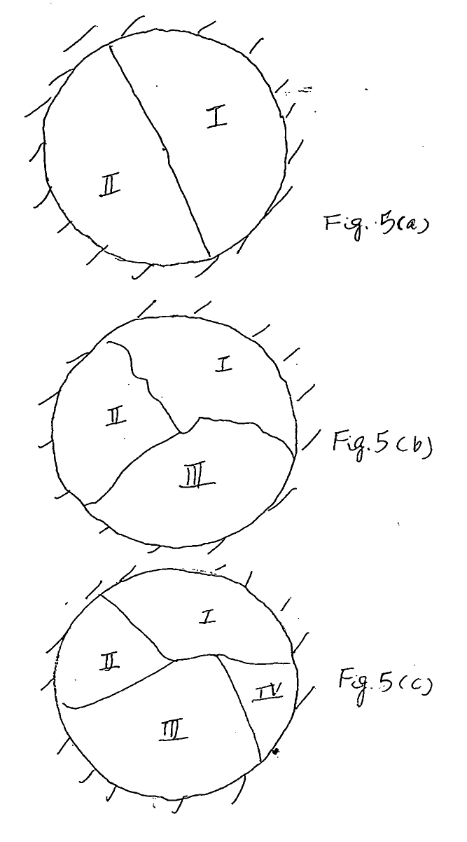

FIGS. 5a-5c show a bottomhole divided into fan-shaped zones in accordance with one embodiment of the invention. FIG. 5a shows two zones, where the zones are divided using lines rather than concentric circles. Further, FIGS. 5b and 5c show that a bottomhole may be divided into several (i.e., more than two) zones.

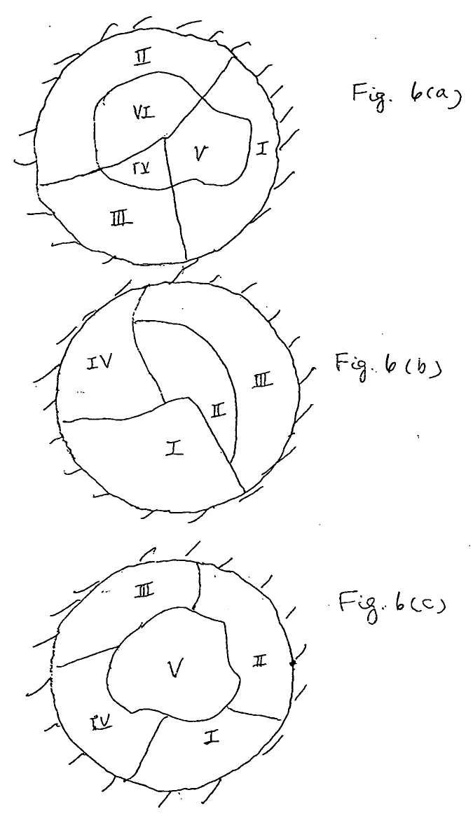

FIGS. 6a-6c show a bottomhole divided into a combination of fan-shaped and concentric circle zones in accordance with one embodiment of the invention. In FIG. 6a, six zone are shown, where zone I includes sub-zone V, zone II includes sub-zone VI, and zone III includes sub-zone IV. Again, those skilled in the art will appreciate that zones may include sub-zones to distinguish between different types of rock formation, different cutting structures associated with the rock bit, etc. In this case, when the simulation and analysis stages are performed, the output results can be viewed for each sub-zone along with each primary zone. FIGS. 6b and 6c show different methods for combined both fan-shaped zones and concentric circle zones to divide the bottomhole into several zones that do not include sub-zones.

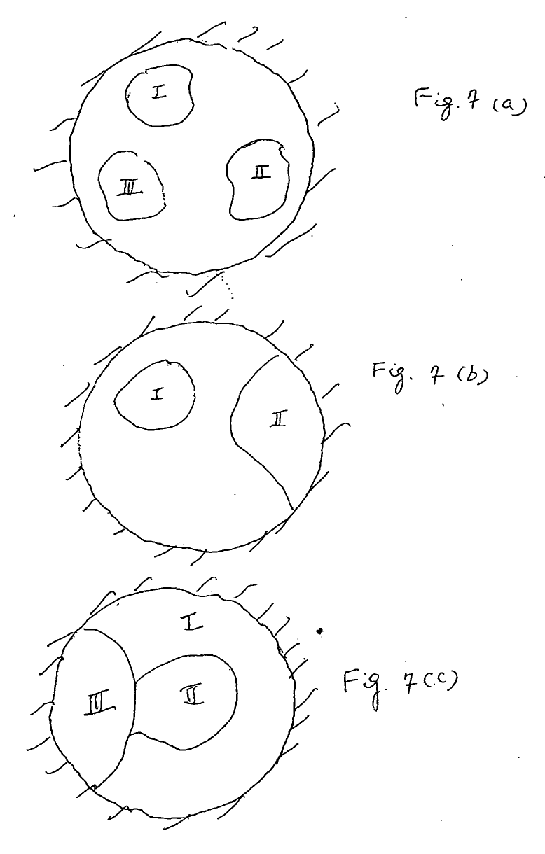

FIGS. 7a-7c show a bottomhole divided into less-limited zones in accordance with one embodiment of the invention. Specifically, FIG. 7a shows three zones, where each zone is not adjacent to any other zone, and where the three zones combined do not cover the entire surface of the bottomhole. In this case, when the simulation and analysis is performed, the results output may be associated with only the defined zoned regions of the bottomhole. This method for dividing the bottomhole may be used, for example, when the simulation of only specific types of rock formation is to be performed, during the final stages of analysis when only the zoned regions need to be refined to determine an optimized layout for design of the rock bit, etc. FIGS. 7b and 7c show further ways to divide the bottomhole using less-limited zones.

Advantageously, embodiments of the present invention allow for a person to analyze a bit design. In particular, embodiments of the present invention allow a person to predict the rock removal rate on a cutting element, row, cone, and/or bit level. As a result of this information, improved bit designs may be realized.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for designing a rock bit, comprising:
dividing a bottomhole into a plurality of zones;
simulating cutting of a rock formation by the rock bit in each of the plurality of zones;
outputting results of said simulation; and
analyzing the results of said simulation.

2. The method of claim 1, further comprising:
modifying at least one cutting element associated with the rock bit based on said analysis to obtain an optimized cutting structure.

3. The method of claim 1, further comprising:
rerunning the simulation based on said analysis.

4. The method of claim 1, further comprising:
selecting cutting structure design parameters; and
selecting rock formation parameters;

5. The method of claim 1, wherein dividing the bottomhole into a plurality of zones comprises dividing the bottomhole into at least one selected from the group consisting of concentric annual zones, fan-shaped zones, and less-limited zones.

6. The method of claim 1, wherein dividing the bottomhole into a plurality of zones comprises dividing the bottomhole based on at least one criterion selected from the group consisting of a surface area of the bottomhole and an energy distribution of the bottomhole.

7. The method of claim 6, wherein a first rock removal rate calculated for a first zone of the plurality of zones differs from a second rock removal rate calculated for a second zone of the plurality of zones by the difference of the surface area of the first zone and the surface area of the second zone.

8. The method of claim 6, wherein a first rock removal rate calculated for a first zone of the plurality of zones differs from a second rock removal rate calculated for a second zone of the plurality of zones by the difference of the energy distribution of the first zone and the energy distribution of the second zone.

9. The method of claim 1, wherein analyzing the results of said simulation comprises one selected from the group consisting of analyzing the stress imposed on cutting structures associated with the rock bit using at least one selected from the group consisting of finite element analysis and finite differences analysis, and sizing the amount of rock removed in each of the plurality of zones.

10. The method of claim 1, wherein outputting results of said simulation comprises at least one selected from the group consisting of outputting a cumulative rock volume removed from at least one zone of the plurality of zones, outputting an incremental rock volume removed from at least one zone of the plurality of zones, outputting an average depth drilled in at least one zone of the plurality of zones, outputting a cumulative rate of penetration for at least one zone of the plurality of zones, outputting an incremental rate of penetration for at least one zone of the plurality of zones, and outputting numerical results using a visual presentation.

11. The method of claim 10, wherein the average depth drilled comprises a cumulative volume for the at least one zone divided by the area of the at least one zone.

12. The method of claim 10, wherein the visual presentation comprises at least one selected from the group consisting of 2D graphics, 3D graphics, charts, tables, and real-time graphics.

13. The method of claim 1, wherein results are outputted to a designer.

14. The method of claim 1, wherein a rock removal rate calculated for at least two zones of the plurality of zones is an optimized ratio of the at least two zones.

15. A system for designing a rock bit, comprising:
a bottomhole divided into a plurality of zones; and
a simulation tool configured to simulate the cutting of a rock formation by the rock bit in each of the plurality of zones and configured to output results of the simulation,
wherein the simulation tool is used to obtain an optimized cutting structure associated with the rock bit.

16. The system of claim 15, wherein outputting results of said simulation comprises at least one selected from the group consisting of outputting a cumulative rock volume removed from at least one zone of the plurality of zones, outputting an incremental rock volume removed from at least one zone of the plurality of zones, outputting an average depth drilled in at least one zone of the plurality of zones, outputting a cumulative rate of penetration for at least one zone of the plurality of zones, outputting an incremental rate of penetration for at least one zone of the plurality of zones, and outputting numerical results using a visual presentation.

17. The system of claim 16, wherein the average depth drilled comprises a cumulative volume for the at least one zone divided by the area of the at least one zone.

18. The system of claim 16, wherein the visual presentation comprises at least one selected from the group consisting of 2D graphics, 3D graphics, charts, tables, and real-time graphics.

19. The system of claim 15, wherein diving the bottomhole into a plurality of zones comprises dividing the bottomhole into at least one selected from the group consisting of concentric annual zones, fan-shaped zones, and less-limited zones.

20. The system of claim 15, wherein dividing the bottomhole into a plurality of zones comprises dividing the bottomhole based on at least one criterion selected from the group consisting of a surface area of the bottomhole and an energy distribution of the bottomhole.

21. The system of claim 20, wherein a first rock removal rate calculated for a first zone of the plurality of zones differs from a second rock removal rate calculated for a second zone of the plurality of zones by the difference of the surface area of the first zone and the surface area of the second zone.

22. The system of claim 20, wherein a first rock removal rate calculated for a first zone of the plurality of zones differs from a second rock removal rate calculated for a second zone of the plurality of zones by the difference of the energy distribution of the first zone and the energy distribution of the second zone.

23. The system of claim 15, wherein the output results of said simulation are analyzed to determine whether a plurality of cutting structures associated with the rock bit need to be modified.

24. The system of claim 23, wherein the simulation is re-run, if the plurality of cutting structures are modified based on the analysis of the output results.

25. The system of claim 23, wherein analyzing the results of said simulation comprises analyzing the stress imposed on cutting structures associated with the rock bit using at least one selected from the group consisting of finite element analysis and finite differences analysis and sizing the amount of rock removed in each of the plurality of zones.

26. The system of claim 15, wherein a rock removal rate calculated for at least two zones of the plurality of zones is an optimized ratio of the at least two zones.

27. A method for analyzing a bit design, comprising:
calculating an amount of rock removed in a first zone;
calculating an amount of rock removed in a second zone; and
analyzing the calculated amount of rock removed in the first zone and the second zone.
